(19) United States
(12) Patent Application Publication
(10) Pub. No.: US 2023/0397142 A1
(43) Pub. Date: Dec. 7, 2023

(54) FLIGHT PATH BASED USER EQUIPMENT AUTONOMOUS TIMING ADVANCE COMPENSATION

(71) Applicant: QUALCOMM Incorporated, San Diego, CA (US)

(72) Inventors: Changhwan PARK, San Diego, CA (US); Umesh PHUYAL, San Diego, CA (US); Wanshi CHEN, San Diego, CA (US); Liangping MA, San Diego, CA (US); Le LIU, San Jose, CA (US); Xiao Feng WANG, San Diego, CA (US); Alberto RICO ALVARINO, San Diego, CA (US); Chiranjib SAHA, San Diego, CA (US); Peter GAAL, San Diego, CA (US); Kiran VENUGOPAL, Green Brook, NJ (US)

(21) Appl. No.: 18/322,273

(22) Filed: May 23, 2023

Related U.S. Application Data
(60) Provisional application No. 63/365,672, filed on Jun. 1, 2022.

(51) Int. Cl. H04W 56/00; H04W 64/00

(52) U.S. Cl. CPC H04W 56/0045; H04W 64/006

(57) ABSTRACT

Various aspects of the present disclosure generally relate to wireless communication. In some aspects, a user equipment (UE) may transmit, to a network node, flight path information that indicates a planned flight path of the UE. The UE may receive, from the network node, timing advance compensation configuration information associated with the planned flight path of the UE and an indication of at least one application criterion associated with the timing advance compensation configuration information. The UE may transmit, to the network node, an uplink communication using a timing advance based at least in part on the timing advance compensation configuration information, in connection with a determination that the at least one application criterion is satisfied. Numerous other aspects are described.

### CROSS-REFERENCE TO RELATED APPLICATION

This Patent application claims priority to U.S. Provisional Patent Application No. 63/365,672, filed on Jun. 1, 2022, entitled “FLIGHT PATH BASED USER EQUIPMENT AUTONOMOUS TIMING ADVANCE COMPENSATION” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for flight path based user equipment (UE) autonomous timing advance compensation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to transmit, to a network node, flight path information that indicates a planned flight path of the UE. The one or more processors may be configured to receive, from the network node, timing advance compensation configuration information associated with the planned flight path of the UE and an indication of at least one application criterion associated with the timing advance compensation configuration information. The one or more processors may be configured to transmit, to the network node, an uplink communication using a timing advance based at least in part on the timing advance compensation configuration information, in connection with a determination that the at least one application criterion is satisfied.

Some aspects described herein relate to a network node for wireless communication. The network node may include one or more memories and one or more processors coupled to the one or more memories. The one or more processors may be configured to receive, from a UE, flight path information that indicates a planned flight path of the UE. The one or more processors may be configured to transmit, to the UE, timing advance compensation configuration information based at least in part on the planned flight path of the UE and an indication of at least one application criterion associated with the timing advance compensation configuration information. The one or more processors may be configured to receive, from the UE, an uplink communication using a timing advance based at least in part on the timing advance compensation configuration information and the at least one application criterion.

Some aspects described herein relate to a method of wireless communication performed by a UE. The method may include transmitting, to a network node, flight path information that indicates a planned flight path of the UE. The method may include receiving, from the network node, timing advance compensation configuration information associated with the planned flight path of the UE and an indication of at least one application criterion associated with the timing advance compensation configuration information. The method may include transmitting, to the network node, an uplink communication using a timing advance based at least in part on the timing advance compensation configuration information, in connection with a determination that the at least one application criterion is satisfied.

Some aspects described herein relate to a method of wireless communication performed by a network node. The method may include receiving, from a UE, flight path information that indicates a planned flight path of the UE. The method may include transmitting, to the UE, timing advance compensation configuration information based at least in part on the planned flight path of the UE and an indication of at least one application criterion associated with the timing advance compensation configuration information. The method may include receiving, from the UE, an uplink communication using a timing advance based at least in part on the timing advance compensation configuration information and the at least one application criterion.

Some aspects described herein relate to a non-transitory computer-readable medium that stores a set of instructions for wireless communication by a UE. The set of instructions, when executed by one or more processors of the UE, may cause the UE to transmit, to a network node, flight path information that indicates a planned flight path of the UE. The set of instructions, when executed by one or more processors of the UE, may cause the UE to receive, from the network node, timing advance compensation configuration information associated with the planned flight path of the UE and an indication of at least one application criterion associated with the timing advance compensation configuration information. The set of instructions, when executed by one or more processors of the UE, may cause the UE to transmit, to the network node, an uplink communication using a timing advance based at least in part on the timing advance compensation configuration information, in connection with a determination that the at least one application criterion is satisfied.

Some aspects described herein relate to a non-transitory computer-readable medium that stores a set of instructions for wireless communication by a network node. The set of instructions, when executed by one or more processors of the network node, may cause the network node to receive, from a UE, flight path information that indicates a planned flight path of the UE. The set of instructions, when executed by one or more processors of the network node, may cause the network node to transmit, to the UE, timing advance compensation configuration information based at least in part on the planned flight path of the UE and an indication of at least one application criterion associated with the timing advance compensation configuration information. The set of instructions, when executed by one or more processors of the network node, may cause the network node to receive, from the UE, an uplink communication using a timing advance based at least in part on the timing advance compensation configuration information and the at least one application criterion.

Some aspects described herein relate to an apparatus for wireless communication. The apparatus may include means for transmitting, to a network node, flight path information that indicates a planned flight path. The apparatus may include means for receiving, from the network node, timing advance compensation configuration information associated with the planned flight path and an indication of at least one application criterion associated with the timing advance compensation configuration information. The apparatus may include means for transmitting, to the network node, an uplink communication using a timing advance based at least in part on the timing advance compensation configuration information, in connection with a determination that the at least one application criterion is satisfied.

Some aspects described herein relate to an apparatus for wireless communication. The apparatus may include means for receiving, from a UE, flight path information that indicates a planned flight path of the UE. The apparatus may include means for transmitting, to the UE, timing advance compensation configuration information based at least in part on the planned flight path of the UE and an indication of at least one application criterion associated with the timing advance compensation configuration information. The apparatus may include means for receiving, from the UE, an uplink communication using a timing advance based at least in part on the timing advance compensation configuration information and the at least one application criterion.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an unmanned aerial vehicle (UAV) UE in a wireless communication network environment, in accordance with the present disclosure.

FIG. 5 is a diagram illustrating an example of downlink and uplink transmissions between a network node and a UE in a wireless network, in accordance with the present disclosure.

FIGS. 6-7 are diagrams illustrating examples associated with flight path based UE autonomous timing advance compensation, in accordance with the present disclosure.

FIGS. 8-9 are diagrams illustrating example processes associated with flight path based UE autonomous timing advance compensation, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

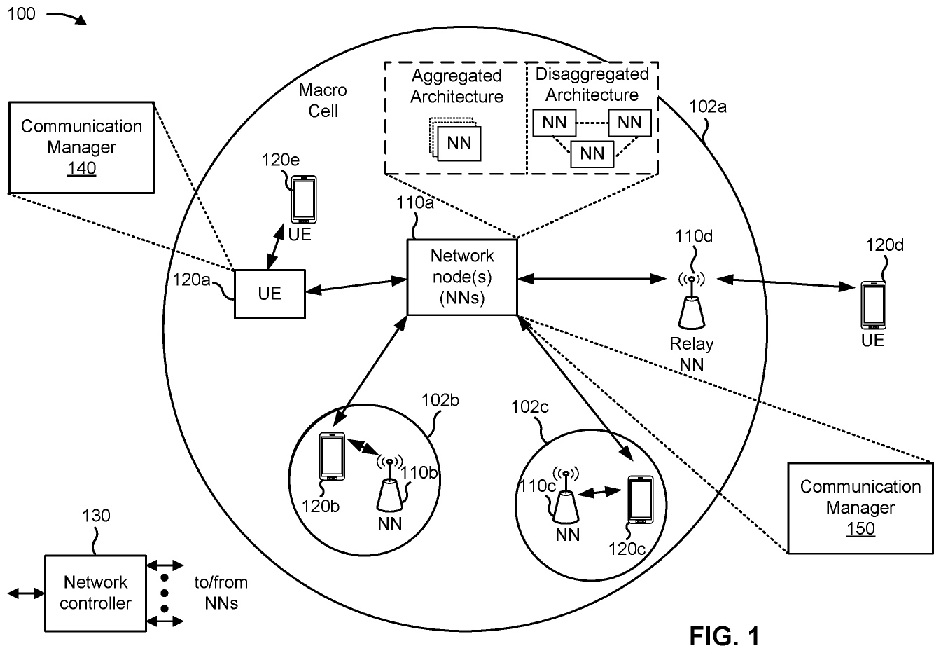

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle (UAV) (e.g., a drone), a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node, flight path information that indicates a planned flight path of the UE; receive, from the network node, timing advance compensation configuration information associated with the planned flight path of the UE and an indication of at least one application criterion associated with the timing advance compensation configuration information; and transmit, to the network node, an uplink communication using a timing advance based at least in part on the timing advance compensation configuration information, in connection with a determination that the at least one application criterion is satisfied. Additionally, or alternatively, the communication manager 140 may perform one or more other operations described herein.

In some aspects, the network node 110 may include a communication manager 150. As described in more detail elsewhere herein, the communication manager 150 may receive, from a UE, flight path information that indicates a planned flight path of the UE; transmit, to the UE, timing advance compensation configuration information associated with the planned flight path of the UE and an indication of at least one application criterion associated with the timing advance compensation configuration information; and receive, from the UE, an uplink communication using a timing advance based at least in part on the timing advance compensation configuration information and the at least one application criterion. In some aspects, the communication manager 150 may also transmit, to the first UE and the second UE, second level shared information for deriving the security key from the common sidelink information. Additionally, or alternatively, the communication manager 150 may perform one or more other operations described herein.

As indicated above, FIG. 1 is provided as an example. Other examples may differ from what is described with regard to FIG. 1.

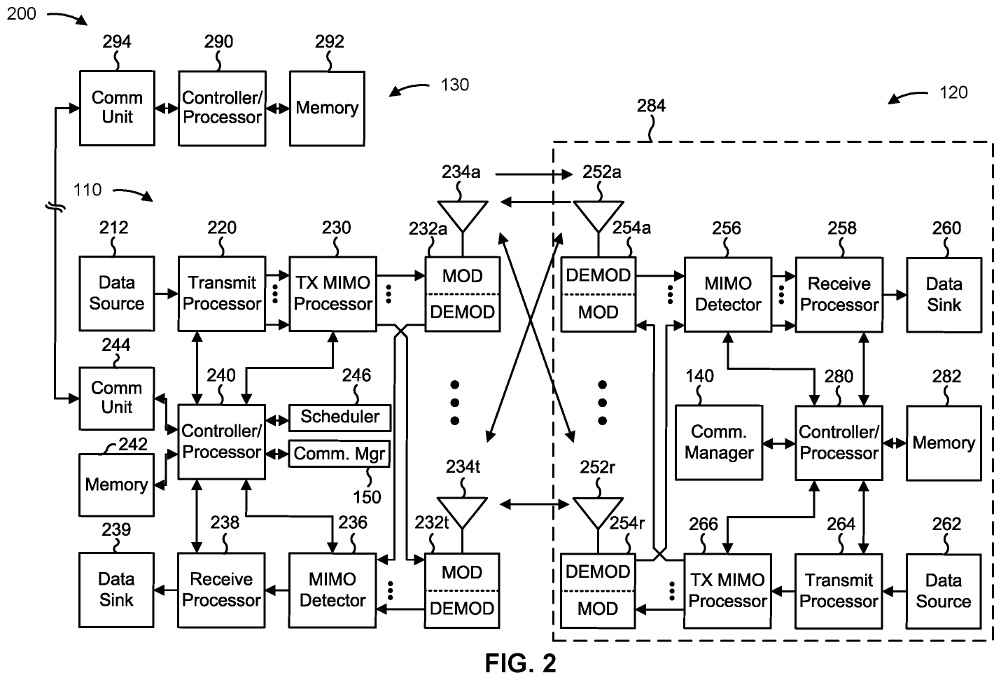

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

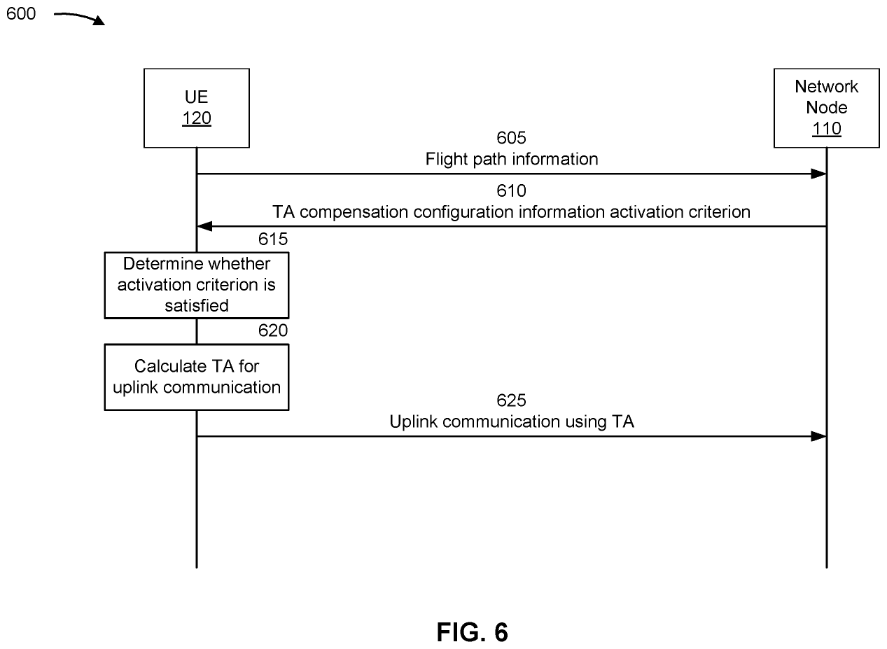

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

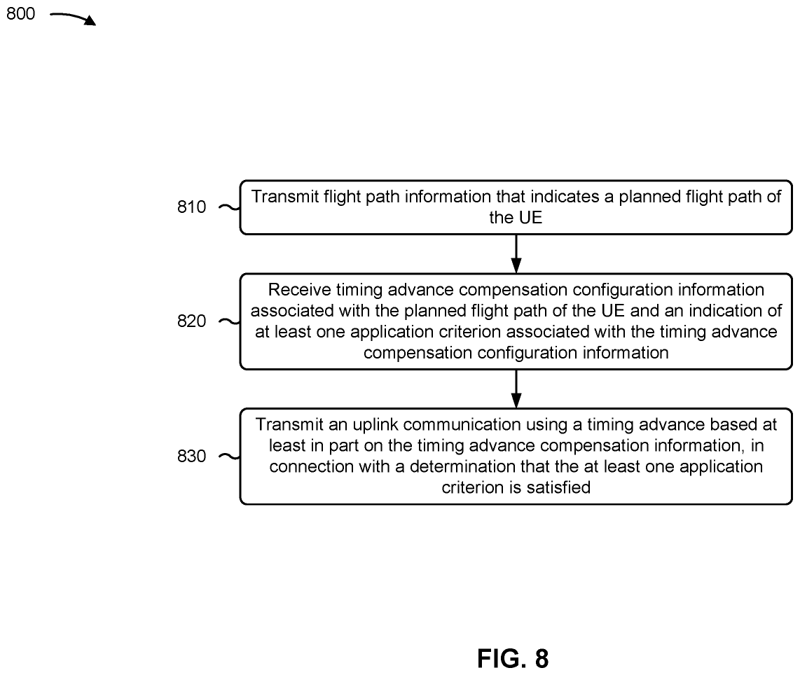

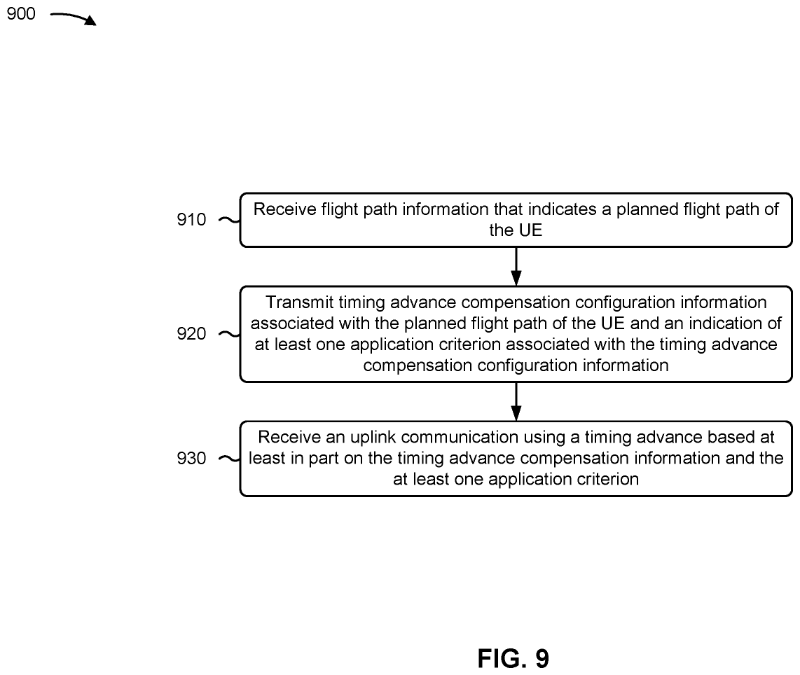

The controller/processor 240 of the network node 110, the controller/processor 280 of the UE 120, and/or any other component(s) of FIG. 2 may perform one or more techniques associated with flight path based UE autonomous timing advance compensation, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node, flight path information that indicates a planned flight path of the UE; means for receiving, from the network node, timing advance compensation configuration information associated with the planned flight path of the UE and an indication of at least one application criterion associated with the timing advance compensation configuration information; and/or means for transmitting, to the network node, an uplink communication using a timing advance based at least in part on the timing advance compensation configuration information, in connection with a determination that the at least one application criterion is satisfied. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, flight path information that indicates a planned flight path of the UE; means for transmitting, to the UE, timing advance compensation configuration information associated with the planned flight path of the UE and an indication of at least one application criterion associated with the timing advance compensation configuration information; and/or means for receiving, from the UE, an uplink communication using a timing advance based at least in part on the timing advance compensation configuration information and the at least one application criterion. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

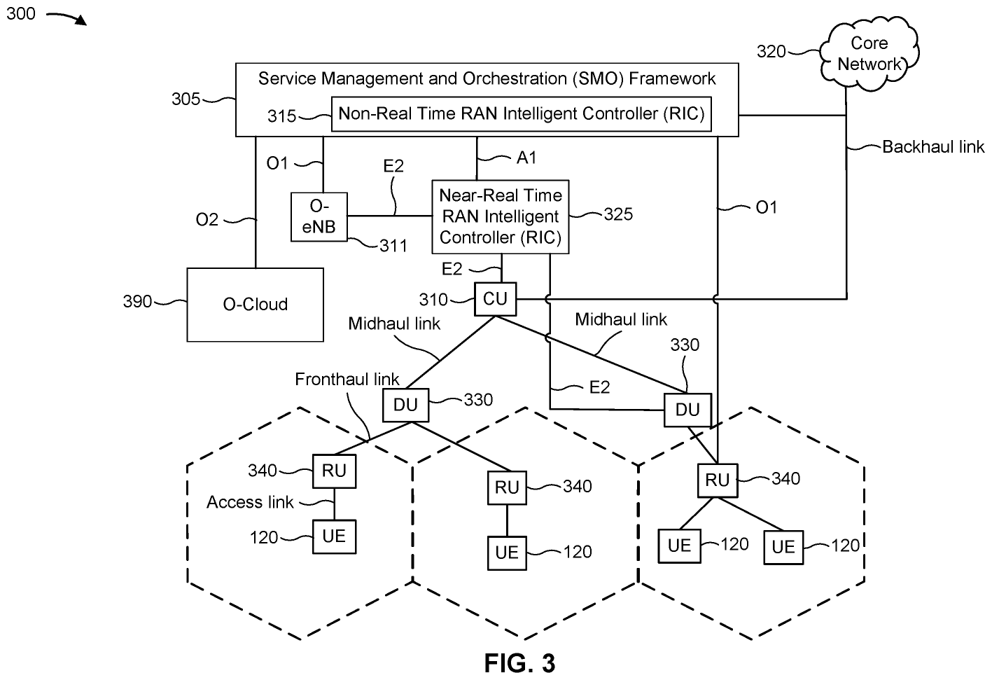

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

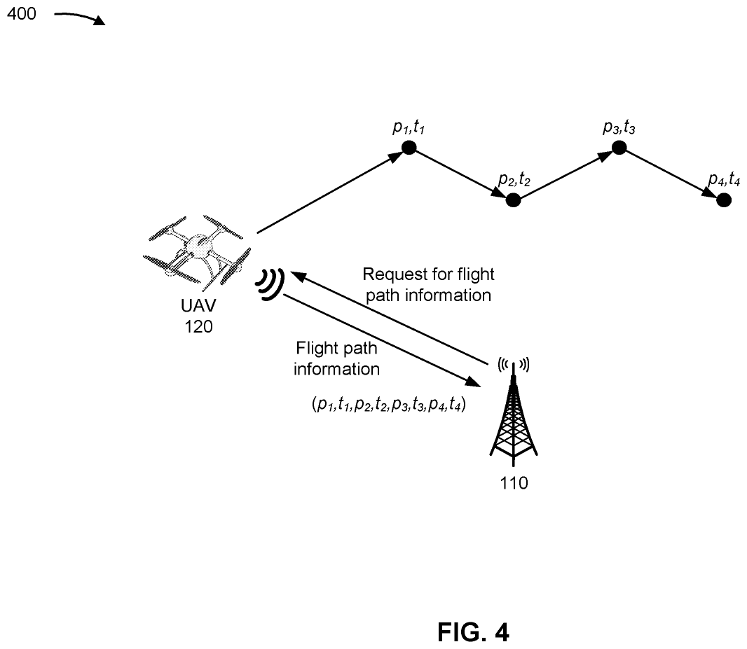

FIG. 4 is a diagram illustrating an example 400 of a UAV UE in a wireless communication network environment, in accordance with the present disclosure. As shown in FIG. 4, example 400 includes a network node 110 and a UAV UE 120 (also referred to herein as the UAV 120).

The UAV 120 includes an aircraft without a human pilot aboard and can also be referred to as an unmanned aircraft (UA), a drone, a remotely piloted vehicle (RPV), a remotely piloted aircraft (RPA), a remotely operated aircraft (ROA), or an uncrewed aerial vehicle. The UAV 120 may have a variety of shapes, sizes, configurations, characteristics, or the like for a variety of purposes and applications. In some implementations, the UAV 120 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. The UAV 120-1 may include one or more components for communicating with one or more network nodes 110.

The UAV 120 may communicate with the network node 110 via a Uu interface. For example, the UAV 120-1 may transmit uplink communications to the network node 110 and/or receive downlink communications from the network node 110 via the Uu interface. Such Uu connectivity may be used to support different applications for the UAV 120-1, such as video transmission from the UAV 120-1 or C2 communications for remote command and control of the UAV 120-1, among other examples.

As shown in FIG. 4, in some examples, the network node 110 may transmit, to the UAV 120, a request for flight path information. The UAV 120 may receive the request for the flight path information, and the UAV 120 may transmit the flight path information to the network node 110 if the flight path information is available at the UAV 120. In some examples, in order to reduce unnecessary signaling, the UAV 120 may indicate, to the network node 110, whether the UAV 120 has flight path information available (e.g., when an RRC connection between the UAV 120 and the network node 110 is initiated). The flight path information may indicate a planned or projected flight path of the UAV 120. In some examples, the flight path information may include a set of waypoints (p₁, p₂, . . . , pₙ) and corresponding time-stamps (t₁, t₂, . . . , tₙ). The waypoints (p₁, p₂, . . . , pₙ) indicate planned or projected positions of the UAV 120, and the time-stamps (t₁, t₂, . . . , tₙ) indicate expected arrival times of the UAV 120 at the corresponding waypoints (p₁, p₂, . . . , pₙ). For example, as shown in FIG. 4, p₁, t₁ indicates a position and an expected arrival time for a first waypoint (Waypoint 1), p₂, t₂ indicates a position and an expected arrival time for a second waypoint (Waypoint 2), p₃, t₃ indicates a position and an expected arrival time for a third waypoint (Waypoint 3), and p₄, t₄ indicates a position and an expected arrival time for a fourth waypoint (Waypoint 4). In some examples, the flight path information may be used by the network to track how many UAVs are to be served in an area at a given time.

As indicated above, FIG. 4 is provided as an example 400 of a UAV. Other examples may differ from what is described with respect to FIG. 4.

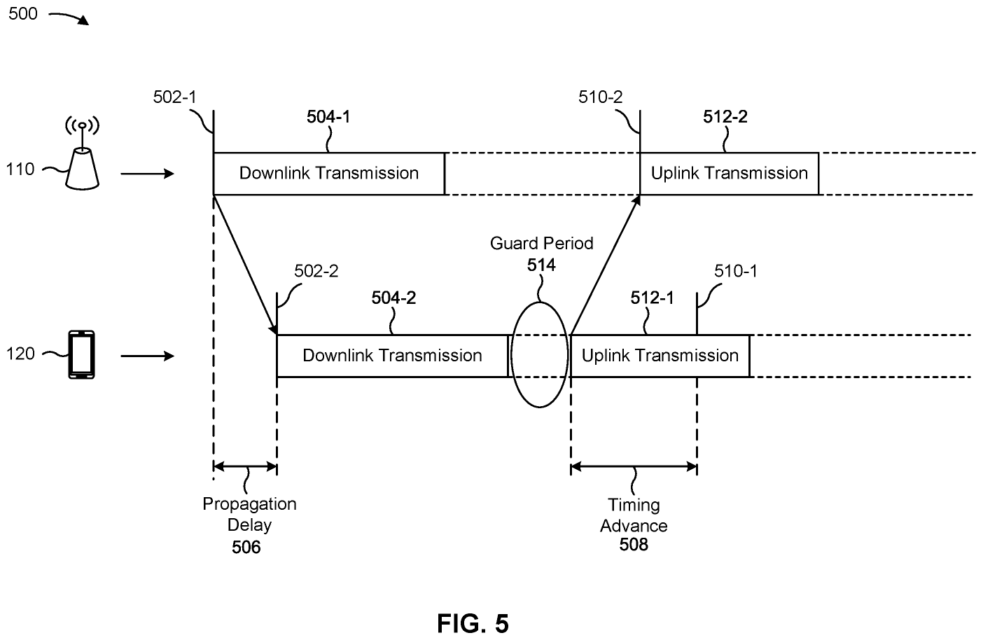

FIG. 5 is a diagram illustrating an example 500 of downlink and uplink transmissions between a network node 110 and a UE 120 in a wireless network 100, in accordance with the present disclosure. In some examples, the downlink and/or uplink transmissions are based at least in part on a timing advance and/or a guard period between communications. As one example, the network node 110 may configure a downlink transmission to end before the start of a guard period. As another example, the UE 120 may advance a start time for an uplink transmission based at least in part on a timing advance.

As shown by reference number 502-1, the network node 110 may begin a downlink transmission 504-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 502-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another based at least in part on the defined time partitions. However, each device may have different timing references for the time partitions. To illustrate, and as shown by the reference number 502-1, the network node 110 may begin the downlink transmission 504-1 at a particular point in physical time that may be associated with a defined time partition based at least in part on a time perspective of the network node 110. For example, the network node 110 may associate the particular point in physical time with a defined time partition, such as a beginning of a symbol, a beginning of a slot, a beginning of a subframe, and/or a beginning of a frame. However, the downlink transmission may incur a propagation delay 506 in physical time, such as a time delay based at least in part on the downlink transmission traveling between the network node 110 and the UE 120. As shown by reference number 502-2, the UE 120 may receive downlink transmission 504-2 (corresponding to downlink transmission 504-1 transmitted by the network node 110) at a second point in physical time that is later in time relative to the first point in physical time. From a time perspective of the UE 120, however, the UE 120 may associate the second point in physical time shown by the reference number 502-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 500, the time perspective of the UE 120 may be delayed in physical time from the time perspective of the network node 110.

In wireless communication technologies like 4G/LTE and 5G/NR, a timing advance (TA) value is used to control a timing of uplink transmissions by a UE (e.g., UE 120) such that the uplink transmissions are received by a network node (e.g., network node 110) at a time that aligns with an internal timing of the network node. The network node may indicate the TA value to a UE by measuring a time difference between reception of uplink transmissions from the UE and a subframe timing used by the network node (e.g., by determining a difference between when the uplink transmissions were supposed to have been received by the network node, according to the subframe timing, and when the uplink transmissions were actually received), and by transmitting a TA command (TAC) to instruct the UE to transmit future uplink communications earlier or later to reduce or eliminate the time difference and align timing between the UE and network node. The TA command is used to offset timing differences between the UE and the network node due to different propagation delays that occur when the UE is different distances from the network node. If TA commands were not used, then uplink transmissions from different UEs (e.g., located at different distances from the network node) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 510-1, a start of the scheduled point in time may occur at a third physical point in time based at least in part on the timing perspective of the UE 120. However, and as shown by reference number 510-2, the scheduled point in time with reference to the timing perspective of the network node 110 may occur at a fourth point in physical time that occurs before the third point in physical time as shown by the reference number 510-1. Accordingly, the network node 110 may instruct the UE 120 to apply a timing advance 508 to an uplink transmission to better align reception of the uplink transmission with the timing perspective of the network node 110. However, in some examples, the fourth point in time shown by the reference number 510-2 may occur at or near a same physical point in time as the third point in time shown by the reference number 510-1 such that uplink transmissions from the UE 120 to the network node 110 incur the propagation delay 506. In such a scenario, the network node 110 may instruct the UE 120 to apply a timing advance with a time duration corresponding to the propagation delay 506.

As shown by the example 500, the UE 120 may adjust a start time of an uplink transmission 512-1 based at least in part on the timing advance 508 and the start of the scheduled point in time (e.g., at the third physical point in time shown by the reference number 510-1). Based at least in part on propagation delay, the network node 110 may receive an uplink transmission 512-2 (corresponding to the uplink transmission 512-1 transmitted by the UE 120) at the fourth point in physical time shown by the reference number 510-2.

In some examples, a timing advance value may be based at least in part on twice an estimated propagation delay (e.g., the propagation delay 506) and/or may be based at least in part on a round trip time (RTT). The network node 110 may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some cases, such as in a random access response or absolute TAC MAC control element (MAC-CE), a TAC (T_{A}) may indicate a TA value N_{TA} to be applied by the UE. For example, the TAC, T_{A}, for a timing advance group (TAG), may indicate N_{TA} values by index values of T_{A}=0, 1, 2, . . . , 3846, where an amount of the time alignment for the TAG with subcarrier spacing (SCS) of 2^{μ}·15 kHz is N_{TA}=T_{A}·16·64/2^{μ}. In this case, the indicated N_{TA} value may be relative to the SCS of a first uplink transmission from the UE after the reception of the random access response (including the TAC) or the absolute TAC MAC-CE. In other cases, a TAC, T_{A}, for a TAG, may indicate an adjustment of a current N_{TA} value, N_{TA_old}, to a new N_{TA} value, N_{TA_new}. For example, the TAC, T_{A}, may indicate the adjustment by index values of T_{A}=0, 1, 2, . . . , 63, where for an SCS of 2^{μ}·15 kHz, N_{TA_new}=N_{TA_old}+(T_{A}−31)·16·64/2^{μ}.

In some examples, the UE may have a capability to follow the frame timing change of a reference cell in connected state. In this case, an uplink transmission by the UE may occur (N_{TA}+N_{TA_offset})×T_{c} before the reception of a first detected path (in time) of a corresponding downlink frame from the reference cell, where N_{TA_offset} is a TA offset value and T_{c} is a basic timing unit. The TA offset value, N_{TA_offset}, may be a constant with a value associated with a duplex mode of the cell in which the uplink transmission occurs and the frequency range. T_{c} may be defined as T_{c}=1/Δfₘₐₓ·N_{f}, where Δfₘₐₓ=480·10³ Hz and N_{f}=4096.

In some examples, a telecommunication system and/or telecommunication standards may define a guard period 514 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 514 may sometimes be referred to as a gap, a switching guard period, or a guard interval.

In some examples, a transmitting device (e.g., the network node 110) may select a starting transmission time and/or a transmission time duration based at least in part on a receiving device and/or the guard period. For example, the network node 110 may select an amount of content (e.g., data and/or control information) to transmit in the downlink transmission 504-1 based at least in part on beginning the transmission at the first point in physical time shown by the reference number 502-1 and/or the UE 120 completing reception of the downlink transmission 504-2 prior to a starting point of the guard period 514. Alternatively, or additionally, the UE 120 may select an amount of content (e.g., data and/or control information) to transmit in the uplink transmission 512-1 based at least in part on the timing advance 508, the third point in physical time shown by the reference number 510-1, and/or refraining from beginning the uplink transmission 512-1 until the guard period 514 has ended.

As indicated above, FIG. 5 is provided as an example. Other examples may differ from what is described with regard to FIG. 5.

In some cases, a network node may serve terrestrial UEs (e.g., a cellular phone, smartphone), a wireless communication device, a vehicular component, or any other non-UAV UE and UAV UEs. A terrestrial UE may be a UE other than a UAV UE, such as a cellular phone (e.g., a smartphone), a wireless communication device, a vehicular component, or any other non-UAV UE. In some cases, an aerial cell that provides coverage for the UAV UEs may be larger than a terrestrial cell that provides coverage for the terrestrial UEs. However, larger distances between the network node and the UAV UEs, as compared with terrestrial UEs, may result in PRACH-based closed loop TA control (e.g., as described above in connection with FIG. 5) being ineffective for UAV UEs. For example, the PRACH-based closed loop TA control used for terrestrial UEs may result in a UE transmission power limit that is too low for UAV UEs. In this case, if the same PRACH format configured for terrestrial UEs is reused for UAV UEs, the maximum ranging distance for the UAV UEs may be limited. Furthermore, using a separate PRACH format for UAV UEs would require a large signaling overhead for the TA update (e.g., to cover a large beam footprint and frequent TA updates), which would result in inefficient resource utilization in the network.

Some techniques and apparatuses described herein enable a network node to configure a UE (e.g., a UAV UE) to perform an autonomous TA adjustment based at least in part on a planned flight path of the UE. In some aspects, the UE may transmit, to the network node, flight path information that indicates the planned flight path of the UE. The UE may receive, from the network node, timing advance compensation configuration information associated with the planned flight path of the UE and an indication of at least one application criterion associated with the timing advance compensation configuration information. The UE, in connection with a determination that the at least one application criterion is satisfied, may transmit, to the network node, an uplink communication using a timing advance based at least in part on the timing advance compensation configuration information. As a result, a UAV UE, once the at least one application criterion is satisfied, may autonomously adjust the TA value in accordance with the flight of the UAV UE.

FIG. 6 is a diagram illustrating an example 600 associated with flight path based UE autonomous TA compensation, in accordance with the present disclosure. As shown in FIG. 6, example 600 includes communication between a network node 110 and a UE 120. In some aspects, the UE 120 may be a UAV UE. The network node 110 and the UE 120 may be included in a wireless network, such as wireless network 100. The network node 110 and the UE 120 may communicate via a wireless access link, which may include an uplink and a downlink.

As shown in FIG. 6, and by reference number 605, the UE 120 may transmit, to the network node 110, flight path information that indicates a planned flight path of the UE 120. The network node 110 may receive the flight path information transmitted by the UE 120. In some aspects, the flight path information may include a set of waypoints (p₁, p₂, . . . , pₙ) The waypoints (p₁, p₂, . . . , pₙ) may indicate a series of planned or projected positions of the UE 120 that define the planned flight path of the UE 120. In some aspects, the flight path information may also include time-stamps (t₁, t₂, . . . , tₙ) that correspond to the waypoints (p₁, p₂, . . . , pₙ). The time-stamps (t₁, t₂, . . . , tₙ) may indicate expected arrival times of the UAV 120 at the corresponding waypoints (p₁, p₂, . . . , pₙ) on the planned flight path of the UE 120.

As further shown in FIG. 6, and by reference number 610, the network node 110 may transmit, to the UE 120, TA compensation configuration information and an indication of at least one application criterion associated with the TA compensation configuration information. The UE 120 may receive the TA compensation configuration information and the indication of the at least one application criterion transmitted by the network node 110. The TA compensation configuration information may be associated with the planned flight path of the UE 120. For example, the network node 110 may determine the TA compensation configuration information based at least in part on the planned flight path of the UE 120.

The TA compensation configuration information may include a set of parameters to configure the UE 120 to perform autonomous TA compensation. In some aspects, the TA compensation configuration information may indicate parameters that configure the UE 120 to determine a semi-open loop TA when the at least one application criterion is satisfied. For example, the TA compensation configuration information may indicate parameters of a polynomial or a set of values to be used by the UE 120 to determine a configured TA compensation value when the at least one application criterion is satisfied.

The at least one application criterion (hereinafter, “application criterion”) may include one or more criteria to be satisfied for the UE 120 to apply the TA compensation configuration information when determining the TA for an uplink communication. In some aspects, the network node 110 may determine the application criterion based at least in part on the planned flight path of the UE 120. In some aspects, the application criterion may include a reference height. In this case, the application criterion may be satisfied when the UE 120 is at or above the reference height. For example, the reference height may be defined as a height from a ground level, an altitude from sea level, or a height corresponding to a position (x, y, z) on the planned flight path of the UE 120.

In some aspects, the application criterion may include a time duration for applying the timing advance compensation configuration information. For example, the application criterion may include an indication of a validity timer with a time duration that determines how long the parameters included in the TA compensation configuration information may be used, by the UE 120, for autonomous TA compensation.

In some aspects, the application criterion may include a reference time at which to begin applying the timing advance compensation configuration information. For example, the reference time may correspond to a time at which the UE 120 is expected to reach a certain height (e.g., the reference height) or position on the planned flight path. In some aspects, the reference time may be an absolute time (e.g., universal time coordinated (UTC)). In some aspects, the reference time may be an epoch time from a specific starting point (e.g., an epoch time from the transmission of the flight path information by the UE 120).

In some aspects, the application criterion may include a reference position, on the planned flight path of the UE 120, at which to begin applying the timing advance compensation configuration information. For example, the reference position may be a position, on the planned flight path, at which the UE 120 reaches a certain height (e.g., the reference height). In some aspects, in a case in which the application criterion includes the reference position, a determination of whether the application criterion is satisfied may be based at least in part on a comparison of the reference position and a nearest position, on the planned flight path of the UE 120, to a current position of the UE 120.

In some aspects, the application criterion may include a threshold for a distance of the UE 120, along the planned flight path of the UE 120, from the reference position on the planned flight path. In this case, the determination of whether the application criterion is satisfied may be based at least in part on a distance between the reference position and a nearest position, on the planned flight path of the UE 120, to a current position of the UE 120.

In some aspects, the application criterion may include a reference zone, along the planned flight path of the UE 120, at which to begin applying the timing advance compensation configuration information. For example, the reference zone may be a zone, of a plurality of configured zones (e.g., geographic areas) along the planned flight path of the UE 120.

In some aspects, the timing advance compensation configuration information indicates parameters of a polynomial for determining configured TA values for one or more uplink transmissions along the planned flight path of the UE 120 (e.g., when the application criterion is satisfied). In some aspects, the TA compensation configuration information may indicate a set of configured TA values associated with the planned flight path of the UE 120. A configured TA value N_{TA,Configured}, determined based at least in part on the TA compensation configuration information, may be a TA value used for autonomous TA compensation by the UE 120, and the configured TA value N_{TA,Configured} may also be referred to as a “configured TA compensation value.”

In some aspects, the TA compensation configuration information may indicate a function (e.g., in polynomial format or as a set of values) of time for determining a configured TA compensation value N_{TA,Configured}. For example, the function for determining N_{TA,Configured} as a function of time may be indicated using parameters similar to the parameters used for deriving a common TA value, N_{TA,common}, for a feeder link in a non-terrestrial network. In some aspects, the TA compensation configuration information may indicate a reference speed to be used with the function of time to determine the configured TA compensation value N_{TA,Configured}. For example, the reference feed may be configured, for the UE 120, by the network node 110 based at least in part on the planned flight path of the UE 120. In this case, the UE 120 may determine the configured TA compensation value N_{TA,configured}, using the function of time, based at least in part on a reference speed.

In some aspects, the TA compensation configuration information indicates a function (e.g., in polynomial format or as a set of values) of distance, for determining the configured TA compensation value N_{TA,Configured}. For example, the function for determining the configured TA compensation value N_{TA,Configured} may be a function of a distance of the UE 120 along the planned flight path. In some aspects, the function may be a function of a distance from a reference position on the planned flight path of the UE 120, to a nearest position, on the planned flight path, to a position of the UE 120. In some aspects, the function may be a function of an integrated distance, over the planned flight path, traveled by the UE 120. In this case, the integrated distance at a particular time may be an integrated distance, over the planned flight path, to a nearest position, on the planned flight path, to an actual position of the UE 120 at that time.

In some aspects, the TA compensation configuration information may indicate a function of a position, associated with the UE 120, for determining the configured TA compensation value N_{TA,Configured} In some aspects, the function for determining the configured TA compensation value N_{TA,configured} may be based at least in part on a center position of a zone, of a plurality of zones along the planned flight path, in which the UE 120 is located. In some aspects, the function for determining the T_{A} compensation value N_{TA,Configured} may be based at least in part on a nearest position, on the planned flight path, to a position of the UE 120. In some aspects, the position (x, y, z) to be used by the UE 120 to determine the configured TA compensation value N_{TA,Configured} at slot N may be a nearest position (x, y, z) on the planned flight path (or a preconfigured flight path) to the actual position of the UE 120 at time N-Tₓ. In this case, Tₓ may be a non-zero value that is autonomously selected by the UE 120 based at least in part on the projected flight speed of the UE 120.

In some aspects, the TA compensation configuration information may indicate a reference location of the network node 110, which may be used by the UE 120 to derive a propagation delay between the network node 110 and the UE 120. In this case, when the application criterion is satisfied, the UE 120 may determine an autonomous TA compensation value N_{TA,Location} based at least in part on the reference location of the network node 110. For example, the UE 120 may derive the propagation delay between the network node 110 and the UE 120 based at least in part on the reference location of the network node 110 and the location of the UE 120, and the UE 120 may determine N_{TA,Location} based at least in part on the propagation delay between the network node 110 and the UE 120. The application criterion, for using the indicated reference location of the network node 110 to determine N_{TA,Location}, may be based at least in part on a reference height, a reference time, a reference position on the planned flight path, a reference zone, or any combination thereof. In some aspects, in a case in which the TA compensation configuration information indicates the reference location of the network node 110 and the application criterion is based at least in part on a reference zone, the reference zone may be defined using a distance from the reference location and azimuth/elevation angles.

As further shown in FIG. 6, and by reference number 615, the UE 120 may determine whether the activation criterion (e.g., the at least one activation criterion) is satisfied. In some aspects, the UE 120 may determine whether the activation criterion is satisfied in connection with calculating the TA for a scheduled uplink communication. For example, the UE 120 may determine whether the activation criterion is satisfied prior to calculating the TA for the scheduled uplink communication.

As shown by reference number 620, the UE 120 may calculate the TA for an uplink communication. In some aspects, the UE 120 may calculate the TA for the uplink communication based at least in part on the determination of whether the application criterion is satisfied.

In some aspects, in connection with a determination that the application criterion is satisfied, the UE 120 may calculate the TA based at least in part on the TA compensation configuration information. In this case, the UE 120 may determine an autonomous TA compensation value (e.g., N_{TA,Configured} or N_{TA,Location}) based at least in part on the TA compensation configuration information, and the UE 120 may adjust a closed loop TA value (e.g., N_{TA}) based at least in part on the autonomous TA compensation value (e.g., N_{TA,Configured} or N_{TA,Location}).

In some aspects, the TA compensation configuration information may indicate a function (e.g., in polynomial format or as a set of values) for determining a configured TA compensation value N_{TA,Configured} For example, the function for determining the configured TA compensation value N_{TA,Configured} may be a function of time, a function of a distance along the planned flight path traveled by the UE 120, or a function of a position of the UE 120, as described above. In this case, when the activation criterion is satisfied, the UE 120 may calculate the total TA (e.g., a combined semi-open loop and closed loop TA) as: T_{TA}=(N_{TA}+N_{TA,Configured}+N_{TA,offset}), where N_{TA} is a closed loop TA value (e.g., based at least in part on one or more TACs, as described above in connection with FIG. 5), N_{TA,Configured} is the configured TA compensation value determined by the UE 120 based at least in part on the TA compensation configuration information, and N_{TA,offset} is a constant/static TA offset value. Using the calculated TA, the UE 120 may determine the uplink transmission (Tx) timing as: Uplink Tx timing=Downlink reception (Rx) timing×Tₛₜ×Tₒₜ×T_{ct}, where Tₒₜ=N_{TA,Configured}×T_{c} is an open loop (or semi-open loop) TA, T_{ct}=N_{TA}×T_{c} is a closed loop TA, and Tₛₜ=N_{TA,offset}×T_{c} is a static TA. In some aspects, the UE 120 may perform loop control for the semi-open loop and closed loop TA as follows: Tₒₜ may be reset for each uplink transmission; T_{ct} may be cumulative (e.g., T_{ct} may accumulate) over multiple uplink transmissions (e.g., based at least in part on differential adjustments to N_{TA}); and Tₛₜ may remain constant.

In some aspects, the TA compensation configuration information may indicate a reference location of the network node 110, as described above. In this case, when the activation criterion is satisfied, the UE 120 may calculate the total TA (e.g., a combined semi-open loop and closed loop TA) as: T_{TA}=(N_{TA}+N_{TA,Location}+N_{TA,offset}), where N_{TA} is the closed loop TA value, N_{TA,Location} is the autonomous TA compensation value determined by the UE 120 based at least in part on the reference location indicated by the TA compensation configuration information, and N_{TA,offset} is the constant/static TA offset value. Using the calculated TA, the UE 120 may determine the uplink Tx timing as: Uplink Tx timing=Downlink Rx timing—Tₛₜ—Tₒₜ—T_{ct}, where Tₒₜ=N_{TA,Location}×T_{c} is the open loop (or semi-open loop) TA, T_{ct}=N_{TA}×T_{c} is the closed loop TA, and Tₛₜ=N_{TA,offset}×T_{c} is the static TA. In some aspects, the UE 120 may perform loop control for the semi-open loop and closed loop TA as follows: Tₒₜ may be reset for each uplink transmission; T_{ct} may be cumulative (e.g., T_{ct} may accumulate) over multiple uplink transmissions (e.g., based at least in part on differential adjustments to N_{TA}); and Tₛₜ may remain constant.

In some aspects, in connection with a determination that the application criterion is not satisfied, the UE 120 may calculate the TA using the closed loop TA, T_{ct}=N_{TA}×T_{c}, and the static TA, Tₛₜ=N_{TA,offset}×T_{c}, without the open loop (or semi-open loop) TA (e.g., Tₒₜ=0). In this case, the UE 120 may calculate the TA for the uplink communication without the autonomous TA compensation value determined using the TA compensation configuration information.

In some aspects, the UE 120 may adjust the loop control for the TA calculation in connection with a transition between different states of the application criterion. In some aspects, for an uplink transmission that is a first uplink transmission after a transition from the application criteria not being satisfied to the application criterion being satisfied (e.g., a first uplink transmission with non-zero Tₒₜ), the UE 120 may reset the closed loop TA, T_{ct}. In some aspects, for an uplink transmission that is a first uplink transmission after a transition from the application criterion being satisfied to the application criterion being not satisfied, the UE 120 may not update Tₒₜ and apply the latest value of Tₒₜ updated prior to the state transition of the application criterion.

As further shown in FIG. 6, and by reference number 625, the UE 120 may transmit, to the network node 110, an uplink communication using the TA calculated for the uplink communication by the UE 120. In some aspects, in a case in which the application criterion is satisfied, the UE 120 may use the TA determined based at least in part on the TA compensation configuration information (e.g., the semi-open loop and closed loop TA with non-zero Tₒₜ) to determine the uplink Tx timing for transmitting the uplink communication. In some aspects, the uplink communication may be a PRACH transmission, and the UE 120, in connection with the determination that the application criterion is satisfied, may apply the TA determined based at least in part on the TA compensation configuration information (e.g., the TA with non-zero Tₒₜ) to the PRACH transmission. In some aspects, in a case in which the application criterion is not satisfied, the UE 120 may use the closed loop TA (e.g., with Tₒₜ=0) to determine the uplink Tx timing for the uplink communication.

In some aspects, the UE 120 may be configured with a parameter that represents a maximum allowed deviation of a position of the UE 120 from the planned flight path indicated by the flight path information reported, to the network node 110, by the UE 120. For example, the network node 110 may transmit, and the UE 120 may receive, an indication of a threshold for the deviation of the position of the UE 120 from the planned flight path. In some aspects, the network node 110 may transmit the indication of the threshold to the UE 120 together with the TA compensation configuration information and the indication of the application criterion. In some aspects, the UE 120 may determine whether the deviation between the actual position of the UE 120 (or a projected position of the UE 120) and the planned flight path satisfies the threshold (e.g., exceeds the threshold). For example, the UE 120 may determine the deviation as a distance between the position of the UE 120 and a nearest point on the planned flight path of the UE 120, or the UE 120 may determine the deviation as a distance between the position of the UE 120 at a certain time and an expected position on the planned flight path (e.g., a waypoint or an interpolated point between waypoints) at that time. In some aspects, in connection with a determination that the deviation between the position of the UE 120 and the planned flight path satisfies the threshold, the UE 120 may transmit, to the network node 110, a request for re-configuration of the TA compensation configuration information. In some aspects, the UE 120 may also transmit, to the network node 110, an updated flight path in connection with the determination that the deviation between the position of the UE 120 and the planned flight path satisfies the threshold. In some aspects, in a case in which the deviation between the position of the UE 120 and the planned flight path satisfies the threshold, the UE 120 may transmit, to the network node 110, a PRACH transmission that applies the TA value derived based at least in part on the TA compensation configuration information (e.g., the configured TA compensation value) plus an additional offset value. In this case, the additional offset value may be applied to prevent the PRACH transmission from arriving, at the network node 110, earlier than an ideal reception slot boundary. The additional offset value may be configured, for the UE 120, by the network node 110 or defined in a wireless communication standard.

In some aspects, the UE 120 may be configured with multiple sets of parameters in the TA compensation configuration information. In some aspects, the TA compensation configuration information, received from the network node 110, may include multiple sets of parameters, with different sets of parameters associated with different cells and/or different synchronization signal blocks (SSBs). For example, the TA compensation configuration information may include at least first timing advance compensation configuration information associated with a first cell or a first SSB and second timing advance compensation configuration information associated with a second cell or a second SSB. In a case in which the UE 120 carries out handover from one cell (e.g., a source cell) to another cell (e.g., a target cell), or in a case in which the UE 120 is served by multiple cells and/or SSBs, the UE 120 may derive the TA value to be applied to an uplink transmission based at least in part on the cell identifier (ID) and/or SSB ID associated with the uplink transmission. In some aspects, in a case in which a first uplink transmission to the new cell is a PRACH transmission, an additional offset value can be applied to the TA value (e.g., to prevent the PRACH transmission from arriving at the network node 110 prior to a slot boundary). In this case, the additional offset value can be a common value across cells, or the additional offset value may be specific to the PRACH format used. In some aspects, the UE may reset the accumulated closed loop TA value (e.g., N_{TA}) upon switching to the target cell. In some aspects, when an uplink transmission, from the UE 120, is intended to be received by multiple cells, the selection of the TA among multiple values for the target cells may be based at least in part on the signal strength of the cells and/or the distance from UE 120 to the cells. For example, the UE 120 may determine the TA value using the TA compensation configuration information associated with the cell with the strongest RSRP and/or the cell with the closest distance from the UE 120. In this case, the accumulated closed loop TA value to be applied may be determined based at least in part on the cell corresponding to the selected TA.

As indicated above, FIG. 6 is provided as an example. Other examples may differ from what is described with respect to FIG. 6.

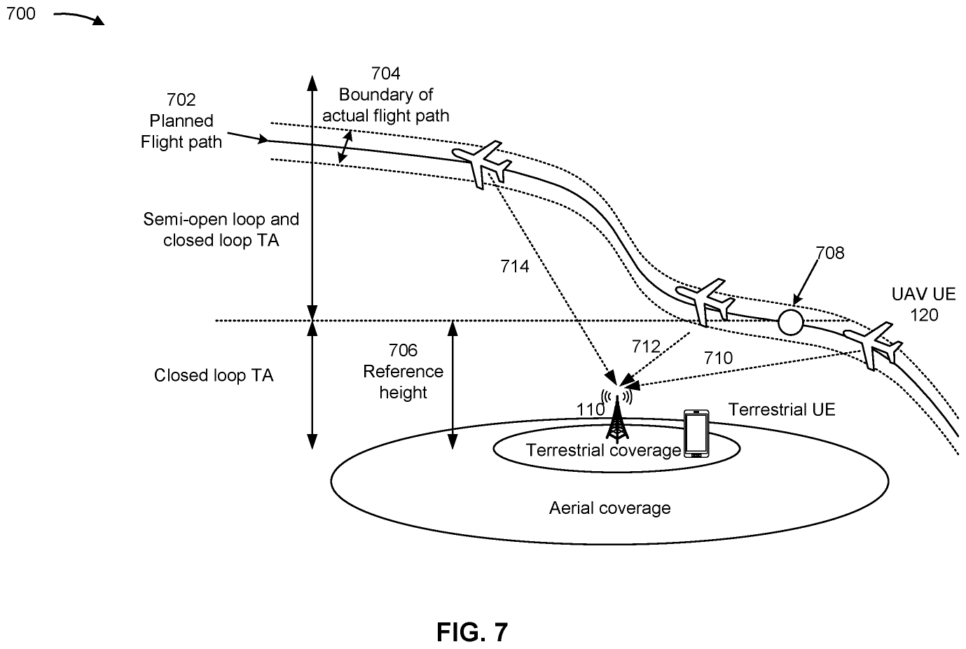

FIG. 7 is a diagram illustrating an example 700 associated with flight path based UE autonomous TA compensation, in accordance with the present disclosure. As shown in FIG. 7, example 700 includes a network node 110 and a UAV UE 120. The network node 110 may provide terrestrial coverage to one or more terrestrial UEs, and the network node 110 may provide aerial coverage for one or more UAV UEs (e.g., UAV UE 120). The UAV UE may transmit, to the network node 110, flight path information that indicates a planned flight path. FIG. 7 shows the planned flight path 702 of the UAV UE 120 and the boundary 704 of the actual flight path of the UAV UE 120.

In some aspects, the activation criterion may be based at least in part on a reference height 706 or a reference point 708 on the planned flight path 702. As shown in FIG. 7, the reference point 708 may be a point, on the planned flight path 702, at which the UAV UE 120 is expected to reach the reference height. In some aspects, the activation criterion may be satisfied when the UE is at or above the reference height 706 (or when the UE passes the reference point 708 on the planned flight path 702).

As shown in FIG. 7, when the UAV UE 120 is below the reference height 706, the UAV UE 120 may use the closed loop TA (e.g., with Tₒₜ=0) for an uplink communication. For example, the UAV UE 120 may transmit a first uplink communication 710 using the closed loop TA, in connection with a determination that the activation criterion is not satisfied (e.g., the UAV UE 120 is below the reference height 706). As shown in FIG. 7, when the UAV UE 120 is at or above the reference height 706, the UAV UE 120 may use the semi-open loop and closed loop TA (e.g., the TA determined based at least in part on the TA compensation configuration information) for an uplink communication. For example, when the UAV UE 120 is above the reference height, the UAV UE 120 may transmit a second uplink communication 712 and a third uplink communication 714 using respective TAs determined using the semi-open loop and closed loop TA (e.g., based at least in part on the TA compensation configuration information).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with flight path based UE autonomous timing advance compensation.

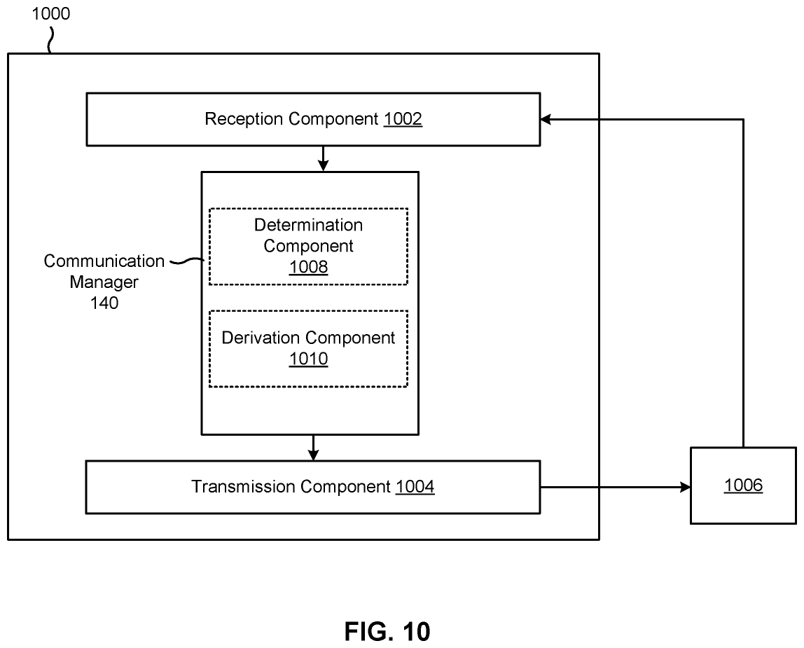

As shown in FIG. 8, in some aspects, process 800 may include transmitting, to a network node, flight path information that indicates a planned flight path of the UE (block 810). For example, the UE (e.g., using communication manager 140 and/or transmission component 1004, depicted in FIG. 10) may transmit, to a network node, flight path information that indicates a planned flight path of the UE, as described above.

As further shown in FIG. 8, in some aspects, process 800 may include receiving, from the network node, timing advance compensation configuration information associated with the planned flight path of the UE and an indication of at least one application criterion associated with the timing advance compensation configuration information (block 820). For example, the UE (e.g., using communication manager 140 and/or reception component 1002, depicted in FIG. 10) may receive, from the network node, timing advance compensation configuration information associated with the planned flight path of the UE and an indication of at least one application criterion associated with the timing advance compensation configuration information, as described above.

As further shown in FIG. 8, in some aspects, process 800 may include transmitting, to the network node, an uplink communication using a timing advance based at least in part on the timing advance compensation configuration information, in connection with a determination that the at least one application criterion is satisfied (block 830). For example, the UE (e.g., using communication manager 140 and/or transmission component 1004, depicted in FIG. 10) may transmit, to the network node, an uplink communication using a timing advance based at least in part on the timing advance compensation configuration information, in connection with a determination that the at least one application criterion is satisfied, as described above.

Process 800 may include additional aspects, such as any single aspect or any combination of aspects described below and/or in connection with one or more other processes described elsewhere herein.

In a first aspect, the at least one application criterion includes a reference height, and the determination that the at least one application criterion is satisfied includes a determination that the UE is at or above the reference height.

In a second aspect, the reference height is a height from a ground level, an altitude from sea level, or a height corresponding to a position along the planned flight path of the UE.

In a third aspect, the timing advance is based at least in part on a cumulative closed-loop timing advance value, an open-loop timing advance value based at least in part on the timing advance compensation configuration information, and a static timing advance offset value, and process 800 includes, in connection with the uplink communication being a first uplink communication once the at least one application criterion is satisfied resetting the cumulative closed-loop timing advance value prior to determining the timing advance for the uplink communication.

In a fourth aspect, the at least one application criterion includes a time duration for applying the timing advance compensation configuration information.

In a fifth aspect, the at least one application criterion includes a threshold for a distance of the UE, along the planned flight path of the UE, from a reference position on the planned flight path.

In a sixth aspect, the at least one application criterion includes a reference time at which to begin applying the timing advance compensation configuration information.

In a seventh aspect, the at least one application criterion includes a reference position, on the planned flight path of the UE, at which to begin applying the timing advance compensation configuration information, and the determination of whether the at least one application criterion is satisfied is based at least in part on a comparison of the reference position and a nearest position, on the planned flight path of the UE, to a current position of the UE.

In an eighth aspect, the at least one application criterion includes a reference zone, along the planned flight path of the UE, at which to begin applying the timing advance compensation configuration information.

In a ninth aspect, the at least one application criterion is based at least in part on the planned flight path of the UE.

In a tenth aspect, the timing advance compensation configuration information indicates a polynomial for determining one or more configured timing advance values associated with the planned flight path.

In an eleventh aspect, the timing advance compensation configuration information indicates a set of configured timing advance compensation values associated with the planned flight path.

In a twelfth aspect, the timing advance compensation configuration information indicates a reference location of the network node.

In a thirteenth aspect, process 800 includes deriving a propagation delay between the network node and the UE based at least in part on the reference location of the network node, in connection with the determination that the at least one application criterion is satisfied, and the timing advance is based at least in part on the propagation delay.

In a fourteenth aspect, the timing advance compensation configuration information indicates a function of time for determining a configured timing advance compensation value, and the timing advance for the uplink communication is based at least in part on the configured timing advance compensation value determined using the function of time.

In a fifteenth aspect, the configured timing advance compensation value is determined, using the function of time, based at least in part on a reference speed associated with the UE.

In a sixteenth aspect, the timing advance compensation configuration information indicates a function of a distance of the UE along the planned flight path, for determining a configured timing advance compensation value, and the timing advance for the uplink communication is based at least in part on the configured timing advance compensation value determined using the function of the distance of the UE along the planned flight path.

In a seventeenth aspect, the distance of the UE along the planned flight path is a distance from a reference position to a nearest position, on the planned flight path, to a position of the UE.

In an eighteenth aspect, the distance of the UE along the planned flight path is an integrated distance, over the planned flight path, to a nearest position, on the planned flight path, to a position of the UE.

In a nineteenth aspect, the timing advance compensation configuration information indicates a function of a position associated with the UE, for determining a configured timing advance compensation value, and the timing advance for the uplink communication is based at least in part on the configured timing advance compensation value determined using the function of the position associated with the UE.

In a twentieth aspect, the position associated with the UE is a center position of a zone, of a plurality of zones along the planned flight path, in which the UE is located.

In a twenty-first aspect, the position associated with the UE is a nearest position, on the planned flight path, to a position of the UE.

In a twenty-second aspect, the timing advance compensation configuration information includes first timing advance compensation configuration information associated with a first cell or a first SSB and second timing advance compensation configuration information associated with a second cell or a second SSB.

In a twenty-third aspect, process 800 includes transmitting, to the network node, another uplink communication, in connection with a determination that the at least one application criterion is no longer satisfied, using a timing advance based at least in part on a previous open-loop timing advance value determined from the timing advance compensation configuration information.

In a twenty-fourth aspect, process 800 includes receiving, from the network node, an indication of a threshold for deviation of a position of the UE from the planned flight path.

In a twenty-fifth aspect, process 800 includes transmitting, to the network node, a request for reconfiguration of the timing advance compensation configuration information in connection with a determination that the deviation of the position of the UE from the planned flight path satisfies the threshold, and receiving, from the network node, updated timing advance compensation configuration information based at least in part on transmitting the request for reconfiguration of the timing advance compensation configuration information.

In a twenty-sixth aspect, process 800 includes transmitting, to the network node, updated flight path information that indicates an updated planned flight path of the UE in connection with the determination that the deviation of the position of the UE from the planned flight path satisfies the threshold, and the updated timing advance compensation configuration information is associated with the updated planned flight path of the UE.

In a twenty-seventh aspect, transmitting the uplink communication includes transmitting, in connection with a determination that the deviation of the position of the UE from the planned flight path satisfies the threshold, a PRACH uplink communication with the timing advance that is based at least in part on the timing advance compensation configuration information adjusted by a configured offset value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with flight path based UE autonomous timing advance compensation.

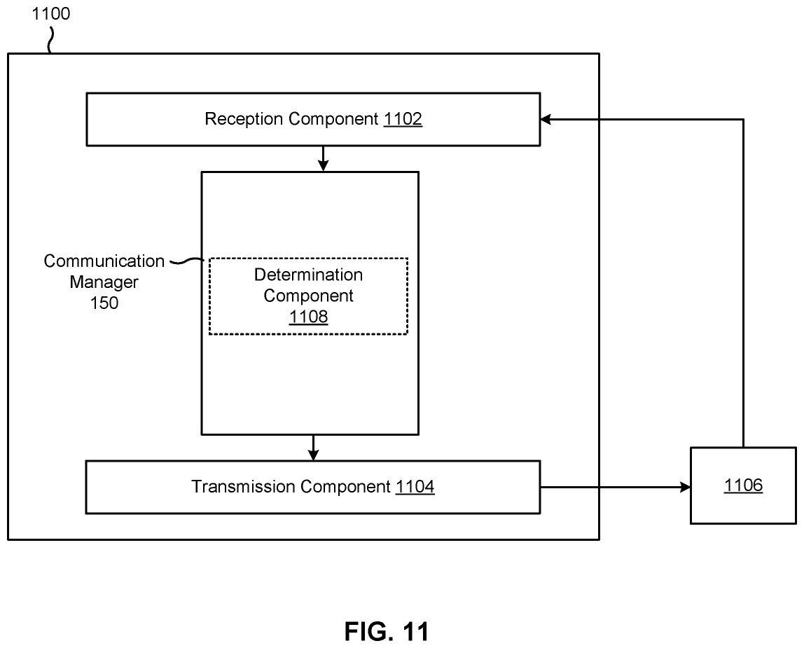

As shown in FIG. 9, in some aspects, process 900 may include receiving, from a UE, flight path information that indicates a planned flight path of the UE (block 910). For example, the network node (e.g., using communication manager 150 and/or reception component 1102, depicted in FIG. 11) may receive, from a UE, flight path information that indicates a planned flight path of the UE, as described above.

As further shown in FIG. 9, in some aspects, process 900 may include transmitting, to the UE, timing advance compensation configuration information based at least in part on the planned flight path of the UE and an indication of at least one application criterion associated with the timing advance compensation configuration information (block 920). For example, the network node (e.g., using communication manager 150 and/or transmission component 1104, depicted in FIG. 11) may transmit, to the UE, timing advance compensation configuration information based at least in part on the planned flight path of the UE and an indication of at least one application criterion associated with the timing advance compensation configuration information, as described above.

As further shown in FIG. 9, in some aspects, process 900 may include receiving, from the UE, an uplink communication using a timing advance based at least in part on the timing advance compensation configuration information and the at least one application criterion (block 930). For example, the network node (e.g., using communication manager 150 and/or reception component 1102, depicted in FIG. 11) may receive, from the UE, an uplink communication using a timing advance based at least in part on the timing advance compensation configuration information and the at least one application criterion, as described above.

Process 900 may include additional aspects, such as any single aspect or any combination of aspects described below and/or in connection with one or more other processes described elsewhere herein.

In a first aspect, the at least one application criterion includes a reference height.

In a second aspect, the reference height is a height from a ground level, an altitude from sea level, or a height corresponding to a position along the planned flight path of the UE.

In a third aspect, the at least one application criterion includes a time duration for applying the timing advance compensation configuration information.

In a fourth aspect, the at least one application criterion includes a threshold for a distance of the UE, along the planned flight path of the UE, from a reference position on the planned flight path.

In a fifth aspect, the at least one application criterion includes a reference time at which to begin applying the timing advance compensation configuration information.

In a sixth aspect, the at least one application criterion includes a reference position, on the planned flight path of the UE, at which to begin applying the timing advance compensation configuration information.

In a seventh aspect, the at least one application criterion includes a reference zone, along the planned flight path of the UE, at which to begin applying the timing advance compensation configuration information.

In an eighth aspect, the at least one application criterion is based at least in part on the planned flight path of the UE.

In a ninth aspect, the timing advance compensation configuration information indicates a polynomial for determining one or more configured timing advance compensation values associated with the planned flight path.

In a tenth aspect, the timing advance compensation configuration information indicates a set of configured timing advance compensation values associated with the planned flight path.

In an eleventh aspect, the timing advance compensation configuration information indicates a reference location of the network node.

In a twelfth aspect, the timing advance compensation configuration information indicates a function of time for determining a configured timing advance compensation value.

In a thirteenth aspect, the timing advance compensation configuration information indicates a reference speed to be used with the function of time for determining the configured timing advance compensation value.

In a fourteenth aspect, the timing advance compensation configuration information indicates a function of a distance of the UE along the planned flight path, for determining a configured timing advance compensation value.

In a fifteenth aspect, the distance of the UE along the planned flight path is a distance from a reference position to a nearest position, on the planned flight path, to a position of the UE.

In a sixteenth aspect, the distance of the UE along the planned flight path is an integrated distance, over the planned flight path, to a nearest position, on the planned flight path, to a position of the UE.

In a seventeenth aspect, the timing advance compensation configuration information indicates a function of a position associated with the UE, for determining a configured timing advance compensation value.

In an eighteenth aspect, the position associated with the UE is a center position of a zone, of a plurality of zones along the planned flight path, in which the UE is located.

In a nineteenth aspect, the position associated with the UE is a nearest position, on the planned flight path, to a position of the UE.

In a twentieth aspect, the timing advance compensation configuration information includes first timing advance compensation configuration information associated with a first cell or a first SSB and second timing advance compensation configuration information associated with a second cell or a second SSB.

In a twenty-first aspect, process 900 includes transmitting, to the UE, an indication of a threshold for deviation of a position of the UE from the planned flight path.

In a twenty-second aspect, process 900 includes receiving, from the UE, a request for reconfiguration of the timing advance compensation configuration information, and transmitting, to the UE, updated timing advance compensation configuration information based at least in part on receiving the request for reconfiguration of the timing advance compensation configuration information.

In a twenty-third aspect, process 900 includes receiving, from the UE, updated flight path information that indicates an updated planned flight path of the UE, and the updated timing advance compensation configuration information is based at least in part on the updated planned flight path of the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a determination component 1008 and/or a derivation component 1010, among other examples.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit, to a network node, flight path information that indicates a planned flight path of the UE. The reception component 1002 may receive, from the network node, timing advance compensation configuration information associated with the planned flight path of the UE and an indication of at least one application criterion associated with the timing advance compensation configuration information. The transmission component 1004 may transmit, to the network node, an uplink communication using a timing advance based at least in part on the timing advance compensation configuration information, in connection with a determination that the at least one application criterion is satisfied.

The determination component 1008 may determine whether the at least one application criterion is satisfied.

The determination component 1008 may determine the timing advance based at least in part on the timing advance compensation configuration information.

The derivation component 1010 may derive a propagation delay between the network node and the UE based at least in part on the reference location of the network node, in connection with the determination that the at least one application criterion is satisfied, wherein the timing advance is based at least in part on the propagation delay.

The transmission component 1004 may transmit, to the network node, another uplink communication, in connection with a determination that the at least one application criterion is no longer satisfied, using a timing advance based at least in part on a previous open-loop timing advance value determined from the timing advance compensation configuration information.

The reception component 1002 may receive, from the network node, an indication of a threshold for deviation of a position of the UE from the planned flight path.

The transmission component 1004 may transmit, to the network node, a request for reconfiguration of the timing advance compensation configuration information in connection with a determination that the deviation of the position of the UE from the planned flight path satisfies the threshold.

The reception component 1002 may receive, from the network node, updated timing advance compensation configuration information based at least in part on transmitting the request for reconfiguration of the timing advance compensation configuration information.

The transmission component 1004 may transmit, to the network node, updated flight path information that indicates an updated planned flight path of the UE in connection with the determination that the deviation of the position of the UE from the planned flight path satisfies the threshold, wherein the updated timing advance compensation configuration information is associated with the updated planned flight path of the UE.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a determination component 1108, among other examples.

In some aspects, the apparatus 1100 may be configured to perform one or more operations described herein in connection with FIGS. 6-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The reception component 1102 may receive, from a UE, flight path information that indicates a planned flight path of the UE. The transmission component 1104 may transmit, to the UE, timing advance compensation configuration information based at least in part on the planned flight path of the UE and an indication of at least one application criterion associated with the timing advance compensation configuration information. The reception component 1102 may receive, from the UE, an uplink communication using a timing advance based at least in part on the timing advance compensation configuration information and the at least one application criterion.

The determination component 1108 may determine the timing advance compensation configuration information and/or the at least one application criterion based at least in part on the planned flight path of the UE.

The transmission component 1104 may transmit, to the UE, an indication of a threshold for deviation of a position of the UE from the planned flight path.

The reception component 1102 may receive, from the UE, a request for reconfiguration of the timing advance compensation configuration information.

The transmission component 1104 may transmit, to the UE, updated timing advance compensation configuration information based at least in part on receiving the request for reconfiguration of the timing advance compensation configuration information.

The reception component 1102 may receive, from the UE, updated flight path information that indicates an updated planned flight path of the UE, wherein the updated timing advance compensation configuration information is based at least in part on the updated planned flight path of the UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting, to a network node, flight path information that indicates a planned flight path of the UE; receiving, from the network node, timing advance compensation configuration information associated with the planned flight path of the UE and an indication of at least one application criterion associated with the timing advance compensation configuration information; and transmitting, to the network node, an uplink communication using a timing advance based at least in part on the timing advance compensation configuration information, in connection with a determination that the at least one application criterion is satisfied.

Aspect 2: The method of Aspect 1, wherein the at least one application criterion includes a reference height, and wherein the determination that the at least one application criterion is satisfied includes a determination that the UE is at or above the reference height.

Aspect 3: The method of Aspect 2, wherein the reference height is a height from a ground level, an altitude from sea level, or a height corresponding to a position along the planned flight path of the UE.

Aspect 4: The method of any of Aspects 1-3, wherein the timing advance is based at least in part on a cumulative closed-loop timing advance value, an open-loop timing advance value based at least in part on the timing advance compensation configuration information, and a static timing advance offset value, and wherein the method further comprises, in connection with the uplink communication being a first uplink communication once the at least one application criterion is satisfied: resetting the cumulative closed-loop timing advance value prior to determining the timing advance for the uplink communication.

Aspect 5: The method of any of Aspects 1-4, wherein the at least one application criterion includes a time duration for applying the timing advance compensation configuration information.

Aspect 6: The method of any of Aspects 1-5, wherein the at least one application criterion includes a threshold for a distance of the UE, along the planned flight path of the UE, from a reference position on the planned flight path.

Aspect 7: The method of any of Aspects 1-6, wherein the at least one application criterion includes a reference time at which to begin applying the timing advance compensation configuration information.

Aspect 8: The method of any of Aspects 1-7, wherein the at least one application criterion includes a reference position, on the planned flight path of the UE, at which to begin applying the timing advance compensation configuration information, wherein the determination of whether the at least one application criterion is satisfied is based at least in part on a comparison of the reference position and a nearest position, on the planned flight path of the UE, to a current position of the UE.

Aspect 9: The method of any of Aspects 1-8, wherein the at least one application criterion includes a reference zone, along the planned flight path of the UE, at which to begin applying the timing advance compensation configuration information.

Aspect 10: The method of any of Aspects 1-9, wherein the at least one application criterion is based at least in part on the planned flight path of the UE.

Aspect 11: The method of any of Aspects 1-10, wherein the timing advance compensation configuration information indicates a polynomial for determining one or more configured timing advance values associated with the planned flight path.

Aspect 12: The method of any of Aspects 1-11, wherein the timing advance compensation configuration information indicates a set of configured timing advance compensation values associated with the planned flight path.

Aspect 13: The method of any of Aspects 1-10, wherein the timing advance compensation configuration information indicates a reference location of the network node.

Aspect 14: The method of Aspect 13, further comprising: deriving a propagation delay between the network node and the UE based at least in part on the reference location of the network node, in connection with the determination that the at least one application criterion is satisfied, wherein the timing advance is based at least in part on the propagation delay.

Aspect 15: The method of any of Aspects 1-12, wherein the timing advance compensation configuration information indicates a function of time for determining a configured timing advance compensation value, and wherein the timing advance for the uplink communication is based at least in part on the configured timing advance compensation value determined using the function of time.

Aspect 16: The method of Aspect 15, wherein the configured timing advance compensation value is determined, using the function of time, based at least in part on a reference speed associated with the UE.

Aspect 17: The method of any of Aspects 1-12 and 15-16, wherein the timing advance compensation configuration information indicates a function of a distance of the UE along the planned flight path, for determining a configured timing advance compensation value, and wherein the timing advance for the uplink communication is based at least in part on the configured timing advance compensation value determined using the function of the distance of the UE along the planned flight path.

Aspect 18: The method of Aspect 17, wherein the distance of the UE along the planned flight path is a distance from a reference position to a nearest position, on the planned flight path, to a position of the UE.

Aspect 19: The method of Aspect 17, wherein the distance of the UE along the planned flight path is an integrated distance, over the planned flight path, to a nearest position, on the planned flight path, to a position of the UE.

Aspect 20: The method of any of Aspects 1-12 and 15-19, wherein the timing advance compensation configuration information indicates a function of a position associated with the UE, for determining a configured timing advance compensation value, and wherein the timing advance for the uplink communication is based at least in part on the configured timing advance compensation value determined using the function of the position associated with the UE.

Aspect 21: The method of Aspect 20, wherein the position associated with the UE is a center position of a zone, of a plurality of zones along the planned flight path, in which the UE is located.

Aspect 22: The method of Aspect 20, wherein the position associated with the UE is a nearest position, on the planned flight path, to a position of the UE.

Aspect 23: The method of any of Aspects 1-22, wherein the timing advance compensation configuration information includes first timing advance compensation configuration information associated with a first cell or a first synchronization signal block (SSB) and second timing advance compensation configuration information associated with a second cell or a second SSB.

Aspect 24: The method of any of Aspects 1-23, further comprising: transmitting, to the network node, another uplink communication, in connection with a determination that the at least one application criterion is no longer satisfied, using a timing advance based at least in part on a previous open-loop timing advance value determined from the timing advance compensation configuration information.

Aspect 25: The method of any of Aspects 1-24, further comprising: receiving, from the network node, an indication of a threshold for deviation of a position of the UE from the planned flight path.

Aspect 26: The method of Aspect 25, further comprising: transmitting, to the network node, a request for reconfiguration of the timing advance compensation configuration information in connection with a determination that the deviation of the position of the UE from the planned flight path satisfies the threshold; and receiving, from the network node, updated timing advance compensation configuration information based at least in part on transmitting the request for reconfiguration of the timing advance compensation configuration information.

Aspect 27: The method of Aspect 26, further comprising: transmitting, to the network node, updated flight path information that indicates an updated planned flight path of the UE in connection with the determination that the deviation of the position of the UE from the planned flight path satisfies the threshold, wherein the updated timing advance compensation configuration information is associated with the updated planned flight path of the UE.

Aspect 28: The method of any of Aspects 25-27, wherein transmitting the uplink communication comprises: transmitting, in connection with a determination that the deviation of the position of the UE from the planned flight path satisfies the threshold, a physical random access channel (PRACH) uplink communication with the timing advance that is based at least in part on the timing advance compensation configuration information adjusted by a configured offset value.

Aspect 29: A method of wireless communication performed by a network node, comprising: receiving, from a user equipment (UE), flight path information that indicates a planned flight path of the UE; transmitting, to the UE, timing advance compensation configuration information based at least in part on the planned flight path of the UE and an indication of at least one application criterion associated with the timing advance compensation configuration information; and receiving, from the UE, an uplink communication using a timing advance based at least in part on the timing advance compensation configuration information and the at least one application criterion.

Aspect 30: The method of Aspect 29, wherein the at least one application criterion includes a reference height.

Aspect 31: The method of Aspect 30, wherein the reference height is a height from a ground level, an altitude from sea level, or a height corresponding to a position along the planned flight path of the UE.

Aspect 32: The method of any of Aspects 29-31, wherein the at least one application criterion includes a time duration for applying the timing advance compensation configuration information.

Aspect 33: The method of any of Aspects 29-32, wherein the at least one application criterion includes a threshold for a distance of the UE, along the planned flight path of the UE, from a reference position on the planned flight path.

Aspect 34: The method of any of Aspects 29-33, wherein the at least one application criterion includes a reference time at which to begin applying the timing advance compensation configuration information.

Aspect 35: The method of any of Aspects 29-34, wherein the at least one application criterion includes a reference position, on the planned flight path of the UE, at which to begin applying the timing advance compensation configuration information.

Aspect 36: The method of any of Aspects 29-35, wherein the at least one application criterion includes a reference zone, along the planned flight path of the UE, at which to begin applying the timing advance compensation configuration information.

Aspect 37: The method of any of Aspects 29-36, wherein the at least one application criterion is based at least in part on the planned flight path of the UE.

Aspect 38: The method of any of Aspects 29-37, wherein the timing advance compensation configuration information indicates a polynomial for determining one or more configured timing advance compensation values associated with the planned flight path.

Aspect 39: The method of any of Aspects 29-38, wherein the timing advance compensation configuration information indicates a set of configured timing advance compensation values associated with the planned flight path.

Aspect 40: The method of any of Aspects 29-37, wherein the timing advance compensation configuration information indicates a reference location of the network node.

Aspect 41: The method of any of Aspects 29-39, wherein the timing advance compensation configuration information indicates a function of time for determining a configured timing advance compensation value.

Aspect 42: The method of Aspect 41, wherein the timing advance compensation configuration information indicates a reference speed to be used with the function of time for determining the configured timing advance compensation value.

Aspect 43: The method of any of Aspects 29-39 and 41-42, wherein the timing advance compensation configuration information indicates a function of a distance of the UE along the planned flight path, for determining a configured timing advance compensation value.

Aspect 44: The method of Aspect 43, wherein the distance of the UE along the planned flight path is a distance from a reference position to a nearest position, on the planned flight path, to a position of the UE.

Aspect 45: The method of Aspect 43, wherein the distance of the UE along the planned flight path is an integrated distance, over the planned flight path, to a nearest position, on the planned flight path, to a position of the UE.

Aspect 46: The method of any of Aspects 29-39 and 41-45, wherein the timing advance compensation configuration information indicates a function of a position associated with the UE, for determining a configured timing advance compensation value.

Aspect 47: The method of Aspect 46, wherein the position associated with the UE is a center position of a zone, of a plurality of zones along the planned flight path, in which the UE is located.

Aspect 48: The method of Aspect 46, wherein the position associated with the UE is a nearest position, on the planned flight path, to a position of the UE.

Aspect 49: The method of any of Aspects 29-48, wherein the timing advance compensation configuration information includes first timing advance compensation configuration information associated with a first cell or a first synchronization signal block (SSB) and second timing advance compensation configuration information associated with a second cell or a second SSB.

Aspect 50: The method of any of Aspects 29-49, further comprising: transmitting, to the UE, an indication of a threshold for deviation of a position of the UE from the planned flight path.

Aspect 51: The method of Aspect 50, further comprising: receiving, from the UE, a request for reconfiguration of the timing advance compensation configuration information; and transmitting, to the UE, updated timing advance compensation configuration information based at least in part on receiving the request for reconfiguration of the timing advance compensation configuration information.

Aspect 52: The method of Aspect 51, further comprising: receiving, from the UE, updated flight path information that indicates an updated planned flight path of the UE, wherein the updated timing advance compensation configuration information is based at least in part on the updated planned flight path of the UE.

Aspect 53: An apparatus for wireless communication at a device, comprising a processor; memory coupled with the processor; and instructions stored in the memory and executable by the processor to cause the apparatus to perform the method of one or more of Aspects 1-28.

Aspect 54: A device for wireless communication, comprising a memory and one or more processors coupled to the memory, the one or more processors configured to perform the method of one or more of Aspects 1-28.

Aspect 55: An apparatus for wireless communication, comprising at least one means for performing the method of one or more of Aspects 1-28.

Aspect 56: A non-transitory computer-readable medium storing code for wireless communication, the code comprising instructions executable by a processor to perform the method of one or more of Aspects 1-28.

Aspect 57: A non-transitory computer-readable medium storing a set of instructions for wireless communication, the set of instructions comprising one or more instructions that, when executed by one or more processors of a device, cause the device to perform the method of one or more of Aspects 1-28.

Aspect 58: An apparatus for wireless communication at a device, comprising a processor; memory coupled with the processor; and instructions stored in the memory and executable by the processor to cause the apparatus to perform the method of one or more of Aspects 29-52.

Aspect 59: A device for wireless communication, comprising a memory and one or more processors coupled to the memory, the one or more processors configured to perform the method of one or more of Aspects 29-52.

Aspect 60: An apparatus for wireless communication, comprising at least one means for performing the method of one or more of Aspects 29-52.

Aspect 61: A non-transitory computer-readable medium storing code for wireless communication, the code comprising instructions executable by a processor to perform the method of one or more of Aspects 29-52.

Aspect 62: A non-transitory computer-readable medium storing a set of instructions for wireless communication, the set of instructions comprising one or more instructions that, when executed by one or more processors of a device, cause the device to perform the method of one or more of Aspects 29-52.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
transmit, to a network node, flight path information that indicates a planned flight path of the UE;
receive, from the network node, timing advance compensation configuration information associated with the planned flight path of the UE and an indication of at least one application criterion associated with the timing advance compensation configuration information; and
transmit, to the network node, an uplink communication using a timing advance based at least in part on the timing advance compensation configuration information, in connection with a determination that the at least one application criterion is satisfied.

2. The UE of claim 1, wherein the at least one application criterion includes a reference height, wherein the determination that the at least one application criterion is satisfied includes a determination that the UE is at or above the reference height, and wherein the reference height is a height from a ground level, an altitude from sea level, or a height corresponding to a position along the planned flight path of the UE.

3. The UE of claim 1, wherein the timing advance is based at least in part on a cumulative closed-loop timing advance value, an open-loop timing advance value based at least in part on the timing advance compensation configuration information, and a static timing advance offset value, and wherein the one or more processors are further configured to:
reset the cumulative closed-loop timing advance value prior to determining the timing advance for the uplink communication in connection with the uplink communication being a first uplink communication once the at least one application criterion is satisfied.

4. The UE of claim 1, wherein the at least one application criterion includes at least one of:
a time duration for applying the timing advance compensation configuration information,
a threshold for a distance of the UE, along the planned flight path of the UE, from a reference position on the planned flight path, or
a reference time at which to begin applying the timing advance compensation configuration information.

5. The UE of claim 1, wherein the at least one application criterion includes a reference position, on the planned flight path of the UE, at which to begin applying the timing advance compensation configuration information, wherein the determination of whether the at least one application criterion is satisfied is based at least in part on a comparison of the reference position and a nearest position, on the planned flight path of the UE, to a current position of the UE.

6. The UE of claim 1, wherein the at least one application criterion includes a reference zone, along the planned flight path of the UE, at which to begin applying the timing advance compensation configuration information.

7. The UE of claim 1, wherein the at least one application criterion is based at least in part on the planned flight path of the UE.

8. The UE of claim 1, wherein the timing advance compensation configuration information indicates a polynomial for determining one or more configured timing advance values associated with the planned flight path.

9. The UE of claim 1, wherein the timing advance compensation configuration information indicates a set of configured timing advance compensation values associated with the planned flight path.

10. The UE of claim 1, wherein the timing advance compensation configuration information indicates a reference location of the network node, and wherein the one or more processors are further configured to:
derive a propagation delay between the network node and the UE based at least in part on the reference location of the network node, in connection with the determination that the at least one application criterion is satisfied, wherein the timing advance is based at least in part on the propagation delay.

11. The UE of claim 1, wherein the timing advance compensation configuration information indicates a function of time for determining a configured timing advance compensation value, wherein the timing advance for the uplink communication is based at least in part on the configured timing advance compensation value determined using the function of time, and wherein the configured timing advance compensation value is determined, using the function of time, based at least in part on a reference speed associated with the UE.

12. The UE of claim 1, wherein the timing advance compensation configuration information indicates a function of a distance of the UE along the planned flight path, for determining a configured timing advance compensation value, wherein the timing advance for the uplink communication is based at least in part on the configured timing advance compensation value determined using the function of the distance of the UE along the planned flight path, and wherein the distance of the UE along the planned flight path is:
a distance from a reference position to a nearest position, on the planned flight path, to a position of the UE, or
an integrated distance, over the planned flight path, to a nearest position, on the planned flight path, to a position of the UE.

13. The UE of claim 1, wherein the timing advance compensation configuration information indicates a function of a position associated with the UE, for determining a configured timing advance compensation value, wherein the timing advance for the uplink communication is based at least in part on the configured timing advance compensation value determined using the function of the position associated with the UE, and wherein the position associated with the UE is
a center position of a zone, of a plurality of zones along the planned flight path, in which the UE is located, or
a nearest position, on the planned flight path, to a position of the UE.

14. The UE of claim 1, wherein the timing advance compensation configuration information includes first timing advance compensation configuration information associated with a first cell or a first synchronization signal block (SSB) and second timing advance compensation configuration information associated with a second cell or a second SSB.

15. The UE of claim 1, wherein the one or more processors are further configured to:
transmit, to the network node, another uplink communication, in connection with a determination that the at least one application criterion is no longer satisfied, using a timing advance based at least in part on a previous open-loop timing advance value determined from the timing advance compensation configuration information.

16. The UE of claim 1, wherein the one or more processors are further configured to:
receive, from the network node, an indication of a threshold for deviation of a position of the UE from the planned flight path;
transmit, to the network node, a request for reconfiguration of the timing advance compensation configuration information in connection with a determination that the deviation of the position of the UE from the planned flight path satisfies the threshold; and
receive, from the network node, updated timing advance compensation configuration information based at least in part on transmitting the request for reconfiguration of the timing advance compensation configuration information.

17. The UE of claim 16, wherein the one or more processors are further configured to:
transmit, to the network node, updated flight path information that indicates an updated planned flight path of the UE in connection with the determination that the deviation of the position of the UE from the planned flight path satisfies the threshold, wherein the updated timing advance compensation configuration information is associated with the updated planned flight path of the UE.

18. The UE of claim 1, wherein the one or more processors, to transmit the uplink communication, are configured to:
receive, from the network node, an indication of a threshold for deviation of a position of the UE from the planned flight path; and
transmit, in connection with a determination that the deviation of the position of the UE from the planned flight path satisfies the threshold, a physical random access channel (PRACH) uplink communication with the timing advance that is based at least in part on the timing advance compensation configuration information adjusted by a configured offset value.

19. A network node for wireless communication, comprising:
one or more memories; and
one or more processors, coupled to the one or more memories, configured to:
receive, from a user equipment (UE), flight path information that indicates a planned flight path of the UE;
transmit, to the UE, timing advance compensation configuration information based at least in part on the planned flight path of the UE and an indication of at least one application criterion associated with the timing advance compensation configuration information; and
receive, from the UE, an uplink communication using a timing advance based at least in part on the timing advance compensation configuration information and the at least one application criterion.

20. The network node of claim 19, wherein the at least one application criterion includes at least one of:
a reference height,
a time duration for applying the timing advance compensation configuration information,
a distance of the UE, along the planned flight path of the UE, from a reference position on the planned flight path,
a reference time at which to begin applying the timing advance compensation configuration information,
a reference position, on the planned flight path of the UE, at which to begin applying the timing advance compensation configuration information, or
a reference zone, along the planned flight path of the UE, at which to begin applying the timing advance compensation configuration information.

21. The network node of claim 19, wherein the timing advance compensation configuration information indicates:
a polynomial for determining one or more configured timing advance compensation values associated with the planned flight path, or
a set of configured timing advance compensation values associated with the planned flight path.

22. The network node of claim 19, wherein the timing advance compensation configuration information indicates a reference location of the network node.

23. The network node of claim 19, wherein the timing advance compensation configuration information indicates:
a function of time for determining a configured timing advance compensation value,
a function of a distance of the UE along the planned flight path, for determining a configured timing advance compensation value, or
a function of a position associated with the UE, for determining a configured timing advance compensation value.

24. The network node of claim 23, wherein the timing advance compensation configuration information indicates a reference speed to be used with the function of time for determining the configured timing advance compensation value.

25. The network node of claim 19, wherein the timing advance compensation configuration information includes first timing advance compensation configuration information associated with a first cell or a first synchronization signal block (SSB) and second timing advance compensation configuration information associated with a second cell or a second SSB.

26. The network node of claim 19, wherein the one or more processors are further configured to:
transmit, to the UE, an indication of a threshold for deviation of a position of the UE from the planned flight path.

27. The network node of claim 26, wherein the one or more processors are further configured to:
receive, from the UE, a request for reconfiguration of the timing advance compensation configuration information; and
transmit, to the UE, updated timing advance compensation configuration information based at least in part on receiving the request for reconfiguration of the timing advance compensation configuration information.

28. The network node of claim 27, wherein the one or more processors are further configured to:
receive, from the UE, updated flight path information that indicates an updated planned flight path of the UE, wherein the updated timing advance compensation configuration information is based at least in part on the updated planned flight path of the UE.

29. A method of wireless communication performed by a user equipment (UE), comprising:
transmitting, to a network node, flight path information that indicates a planned flight path of the UE;
receiving, from the network node, timing advance compensation configuration information associated with the planned flight path of the UE and an indication of at least one application criterion associated with the timing advance compensation configuration information; and
transmitting, to the network node, an uplink communication using a timing advance based at least in part on the timing advance compensation configuration information, in connection with a determination that the at least one application criterion is satisfied.

30. A method of wireless communication performed by a network node, comprising:
receiving, from a user equipment (UE), flight path information that indicates a planned flight path of the UE;
transmitting, to the UE, timing advance compensation configuration information based at least in part on the planned flight path of the UE and an indication of at least one application criterion associated with the timing advance compensation configuration information; and
receiving, from the UE, an uplink communication using a timing advance based at least in part on the timing advance compensation configuration information and the at least one application criterion.
